(19) United States
(12) Patent Application Publication
(10) Pub. No.: US 2026/0298587 A1
(43) Pub. Date: Oct. 1, 2026

(54) ANTI-BALLISTIC PANELS MADE FROM MAGNESIA BASED CEMENT AND SYSTEM COMPRISING SAME

(71) Applicant: UBIQ TECHNOLOGY PTY LTD, Clovelly (AU)

(72) Inventors: Khin Thandar SOE, Clovelly (AU); Mark Stephen PULHAM, Clovelly (AU)

(21) Appl. No.: 19/478,099

(22) PCT Filed: May 2, 2024
(86) PCT No.: PCT/AU2024/050421

§ 371 Date: Oct. 23, 2025

(30) Foreign Application Priority Data
May 2, 2023 (AU) 2023901300

(51) Int. Cl. F41H 5/04; C04B 28/32; C04B 28/34; C04B 111/20; E04B 1/92; E04C 2/04; E04C 2/06

(52) U.S. Cl. CPC F41H 5/04; C04B 28/32; C04B 28/34; E04B 1/92; E04C 2/044; E04C 2/06; C04B 2111/2046; E04B 2103/02

(57) ABSTRACT

An anti-ballistic building panel made substantially from magnesium oxychloride hydrate cement; magnesium oxysulphate hydrate cement; a hybrid of both said materials; and/or magnesium phosphate cement; said cement preferably incorporating one or more high-modulus fibre materials distributed through the cement and one or more low-modulus fibre materials distributed through the cement; a method of manufacture and an anti-ballistic system incorporating same.

### TECHNICAL FIELD

The invention relates to the field of building material manufacture. In particular, the invention relates to the use of magnesia based cement as a ballistic impact resistant panel in a building or other structure requiring ballistic protection. The invention further relates to a particularly advantageous formulation for magnesia-based cement for use in such applications.

### BACKGROUND OF THE INVENTION

Resistance to high velocity impact by projectiles, such as bullets and shrapnel or the like, plays an important role in the ability of protective building structures to directly protect people, or to provide longer time frames for evacuations in the case of impact disasters experienced in e.g. terrorist attacks, firearms attacks, collisions, building collapses, etc.

The impact phenomena created by these projectile collisions, including ballistic collisions, are generally categorised as ‘low’-, ‘high’- and ‘hyper-velocity’, based on the collision speed. In the case of projectile impact, those three categories are commonly defined as: below 50 m/s; between 50 m/s to 1000 m/s; and in the range of 2000 m/s to 5000 m/s; respectively.

Among these, ballistic and small projectile impacts in the high velocity impact categories are of the most interest in the present invention, especially those resulting from small arms fire.

United States Department of Defence Unified Facilities Criteria UFC-4-023-07 (2008) defines ‘small arms’ as including ballistic weapons such as pistols, rifles, shotguns, and submachine guns up to 12.7 mm (0.50 calibre). Some anti-tank weapons are also included, but are not limited to: shoulder fired rockets such as the Russian RPG-7, RPG-18, and RPG-22 and the U.S. M-72 Light Antitank Weapon (LAW).

During a collision between an impactor and a target, an impact stress wave propagation occurs in the target material. The response of the target when subjected to this impact stress wave propagation depends on its mechanical strengths, its stress and strain behaviour, the stiffness of the surrounding structural elements and the type and speed of the impactors.

In low-velocity impact, the impact time is longer and characterised by relatively slowly generating stress waves that are distributed towards the supports or periphery of the target outward from the impact point. This causes the vibration and stress waves to be transferred to the supports.

An impactor with higher velocity has shorter time in contact with the target, therefore the impact wave distribution may not reach to the periphery of the target or the supports. High speed impact will tend to destroy local structural elements in the impact region and more likely lead to perforation of the target.

In addition, the dynamic impact response of the target object depends not only on its mechanical strength and geometry but also on the impact speed, mass, shape and type of impactor projectiles.

Several ballistic impact resistant materials for various purposes are available in the market such as metals, vast, glass, composite materials (resin-based, metal-based, ceramic-based, cement-based composites), and building products such as walling, doors, windows, etc. However, the high cost of these materials tends to limit their ability to be used expansively in civilian and military fields.

Among impact resistant building materials, Ordinary Portland Cement (OPC)-based products are slightly cheaper compared to other impact resistant building materials. The OPC cement-based category is used in civilian residential and commercial buildings and also in the protective structures. This category is generally defined as precast and cast in-situ concrete walls, concrete blocks (e.g. Cinder blocks), fibreglass composite panel, brick veneers, etc. These products can be designed to withstand a certain level of ballistic impact, but tend to be expensive and time-consuming to build, in addition to being heavy non-portable structures.

Although OPC cement-based products have a cost advantage, their inherent brittleness is a significant barrier to solving the problem of providing thinner/lighter products and easier construction while maintaining impact resistance. OPC building products, when subjected to high velocity small projectile impact, tends to shatter due to its inherent brittleness. As a consequence, OPC cement structures, with or without reinforcement, must be built as massive structures to meet the required anti-ballistic performance, e.g. UF4-3 shows the required thickness of selected materials for designed ballistic level.

Accordingly, it is an object of the invention to provide an anti-ballistic material that ameliorates at least some of the problems associated with the prior art.

### SUMMARY OF THE INVENTION

According to a first aspect of the invention, there is provided the use of magnesium oxychloride hydrate cement (MOC), magnesium oxysulphate hydrate cement (MOS), magnesium phosphate cement (MPC), magnesium based activated cement (MAC); or a hybrid of two or more of said materials; as a substrate in the manufacture of an anti-ballistic building panel.

According to a second aspect of the invention, there is provided an anti-ballistic building panel made substantially from a combination of magnesium oxychloride hydrate cement (MOC), magnesium oxysulphate hydrate cement (MOS), magnesium phosphate cement (MPC), and/or magnesium based activated cement (MAC).

Magnesia based cements according to the invention are made from known compositions with modifications for the purpose of improving impact resistance. MOC; MOS; a hybrid of both said materials; MPC, and/or MAC are used and may advantageously be incorporated with one or more of high and low modulus fibres and/or fine and coarse aggregate such as stone chips, river aggregate or sand, and/or fillers such as rice husks, perlite, vermiculite, dolomite, etc.

Preferably, said anti-ballistic building panel incorporates one or more of: high elastic modulus fibres and/or stone chips, preferably granite chips; and low elastic modulus fibres; said fibres and/or chips being distributed through said cement.

The magnesia cement according to the invention has high impact resistance and high flexibility compared to OPC products, which tend to shatter during the impact due to their characteristic brittleness, as illustrated in FIG. 1.

The impact response characteristic of a cement not only depends on its own mechanical properties but also on impact velocity, type and shape of projectiles. Although conventional magnesia cement products exhibit some impact resistance at a certain threat level, it tends not to be able to resist high velocity projectile impacts, as shown in FIG. 2.

A benefit of the high flexibility magnesia cement according to the invention is that it provides a largely intact post-impact surface in both the impact and distal sides of a panel made from the material.

Accordingly, the invention provides a relatively light-weight, thin, transportable, and affordable magnesia cement-based building panel that is impact resistant, particularly in relation to ballistic impact. This allows the construction of anti-ballistic buildings without the need for heavy construction techniques, and which allow relatively quick installation and demolition. In addition, the panels may be re-used.

In this invention, the various examples of magnesia cement are modified for ballistic performance. In order to improve stiffness and impact resistance, the magnesia cement incorporates industrial by-product cementitious materials, low and/or high modulus fibre, organic fibre, fine and coarse aggregates and additives.

Modulus of elasticity represents the stiffness of the materials. High elastic modulus fibres have high material stiffness but permanent deformation is likely under stress or strain; low elastic modulus fibres are longitudinally flexible, or ‘stretchy’.

Preferably, said high-modulus fibre are one or more materials selected from the group comprising: carbon fibre, steel fibre, copper fibre, Kevlar, titanium, graphite, and glass fibre staples. Preferably, said low-modulus material are selected from the group comprising: PVA, PP and PE. Preferably, said building panel also incorporates with coarse aggregate, preferably stone chips having a Moh's scale of hardness in the range 5-7 and between 1 mm and 20 mm in largest dimension; said stone preferably being granite, blue metal and/or basalt.

Preferably, the incorporation of high-modulus fibre material or coarse aggregate is between 0.5% to 1.0% by mass of said cement; and the incorporation of low-modulus fibre material is in the range 1.2% to 2.0% by mass of said cement.

Preferably, said building panel incorporates one or more of the following: expanded perlite; organic waste fibre; aluminium oxide grains of between 1 mm and 5 mm in size; and exfoliated vermiculite.

The invention provides an improved magnesia cement having superior performance relating to high velocity impact responses, particularly with regard to mechanical strength, ductility, and toughness of the matrix.

Among the various failure modes resulting from high velocity small projectile impact, perforation is a major concern for magnesia cement panels, whereas the invention provides panels having higher mechanical flexibility, which in turn reduces the risk of shattering and perforation failure.

According to another aspect of the invention, there is provided a structure incorporating anti-ballistic panels made at least partially form an anti-ballistic building panel according to any described above.

According to another aspect of the invention, there is provided the use of magnesium cement in the construction of anti-ballistic building panels; wherein said magnesium cement is selected from one of more of: magnesium oxychloride hydrate cement; magnesium oxysulphate hydrate cement; a hybrid of both said materials; and/or magnesium phosphate cement; said cement also incorporating one or more high-modulus fibre materials distributed through the cement and one or more low-modulus fibre materials distributed through the cement.

According to another aspect of the invention, there is provided a method of manufacture of magnesium cement, wherein said magnesia cement is selected from one of more of: magnesium oxychloride hydrate cement; magnesium oxysulphate hydrate cement; a hybrid of both said materials; and/or magnesium phosphate cement; said method including the incorporation in said cement of one or more high-modulus fibre materials distributed through the cement and one or more low-modulus fibre materials distributed through the cement.

Preferably, said method further includes the step of incorporating any stone particles which have Moh's scale of hardness greater than 5 or wherein said stone particles provides an average hardness of greater than 5 Moh's scales. Preferably, the stone is blue metal, basalt or granite. Said method preferably further includes the step of incorporating in said cement one or more materials selected from the group comprising: expanded perlite; organic by-product fibre; aluminium oxide grains; perlite and exfoliated vermiculite.

According to another aspect of the invention, there is provided the use of magnesium oxychloride hydrate cement, magnesium oxysulphate hydrate cement, magnesium phosphate cement; or a hybrid of one or more of said materials; as a substrate in the manufacture of an anti-ballistic building panel.

According to another aspect of the invention, there is provided an anti-ballistic building panel made substantially from magnesium oxychloride hydrate cement; magnesium oxysulphate hydrate cement; a hybrid of both said materials; and/or magnesium phosphate cement; said cement also incorporating one or more of high elastic modulus fibres and/or stone chips, preferably granite chips; and low elastic modulus fibres; said fibres and/or chips being distributed through said cement.

According to another aspect of the invention, there is provided a structure incorporating anti-ballistic panels made at least partially from an anti-ballistic building panel according to any described above.

According to another aspect of the invention, there is provided the use of magnesium cement in the construction of anti-ballistic building panels; wherein said magnesia cement is selected from one of more of: magnesium oxychloride hydrate cement; magnesium oxysulphate hydrate cement; a hybrid of both said materials; and/or magnesium phosphate cement; said cement also incorporating one or more high-modulus fibre materials distributed through the cement and one or more low-modulus fibre materials distributed through the cement.

According to another aspect of the invention, there is provided a method of manufacture of magnesia cement, wherein said magnesia cement is selected from one of more of: magnesium oxychloride hydrate cement; magnesium oxysulphate hydrate cement; a hybrid of both said materials; and/or magnesium phosphate cement; said method including the incorporation in said cement of one or more high-modulus fibre materials distributed through the cement and one or more low-modulus fibre materials distributed through the cement.

Now will be described, by way of specific, non-limiting examples, preferred embodiments of the invention with reference to the figures.

### BRIEF DESCRIPTION OF THE DRAWINGS

FIGS. 1a to 1f shows failure modes of (50 mm thick OPC and engineered cementitious composite (ECC) panels), according to the prior art, when subjected to high velocity small projectile impacts: (a) front and (b) back of OPC 45 grade panel subjected to an impact velocity of 312 m/s; (b) front and (c) and back of OPC 45 grade panel subjected to an impact velocity of 441 m/s; (e) front and (f) back of hybrid fibre ECC panel subjected to an impact velocity of 524.5 m/s.

FIGS. 2a and 2b show UBIQ INEX 19 mm thick non-ballistic magnesium cement panels subjected to the ballistic impact of .22 Long Rifle, 0.22 Magnum Rifle and 30-30 Winchester with the impact velocity of 178 J, 439 J and 2390 J, respectively; (a) front, (b) back.

FIG. 3 shows a ballistic cladding systems according to the invention—SIP panels and solid panels.

FIG. 4 shows an Armor-MAG Cladding SIP Panel System according to the invention.

FIGS. 5a and 5b shows perforation failure mode of inventive Armor-MAG specimens: (a) impact surface with scabbing and (b) distal surface with spalling with a large intact surface.

FIG. 6 shows a schematic graph gas gun impact test set-up.

FIG. 7 shows a high velocity steel ball impact gas-gun setting.

FIG. 8 shows Absorbed Energy and thickness of Armor-MAG subjected to steel ball projectile impact.

FIG. 9 shows toughness and thickness of Armor-MAG subjected to steel ball projectile impact.

FIGS. 10a to 10f shows post-failure modes for: 36 mm-Armor-MAG solid panels for steel projectile impact velocity limit: front (a) and (d) distal (b) and (e) surfaces; and (c) and (f) show non-ricochet bullets after the impact on specimens with no steel fibre inclusion (at 417 m/s) and with steel fibre inclusion (at 412 m/s), respectively.

FIG. 11 shows post impact observation of Armor-MAG 4×22 solid layers subjected to an impact velocity of 816 m/s.

FIG. 12 shows a schematic graph of a ballistic test set-up as per AS/NZS 2343-1997.

FIG. 13 shows a ballistic test set-up according to AS/NZS 2343-1997.

FIG. 14 shows a SIP 22-22 Amor-MAG panel subjected to ballistic impacts: G1 (AS/NZS 2343) and UL-level 3.

FIG. 15 shows SIP 44-22 Amor-MAG panel subjected to the ballistic impacts: G2 (AS/NZS 2343) UL-level 7 and AK-47.

FIG. 16 shows SIP 88-22 and 66-22 Amor-MAG panels subjected to ballistic impacts: S0 (AS/NZS 2343) and UL-level 8 (NATO).

FIG. 17 shows various SIP panels with permanent metal formwork (0.55 bmt colour-bond in this test) subjected to the thread Class S1, R1 and NATO (AS/NZS 2343).

FIG. 18 shows the setup of a 25-25 SIP panel according to the invention with permanent formwork for fire testing.

FIG. 19 shows the results of the 4 hours fire rating test of the 25-25 SIP panel of FIG. 18.

FIG. 20 is a flowchart illustrating the basic MOC manufacturing process.

### DETAILED DESCRIPTION OF THE INVENTION

The invention relates most broadly to the use of magnesia cements, such as magnesium oxychloride hydrate cement; magnesium oxysulphate hydrate cement; a hybrid of both said materials; magnesium phosphate cement and/or activated magnesia cement as the basis for panels or other building components, in buildings intended to have anti-ballistic performance.

More particularly, the invention provides modifications to said magnesia cements to improve impact resistance and which enhances the anti-ballistic properties of these cement materials to an extent hitherto unknown in the prior art for these types of materials.

Compared with conventional OPC, magnesia cement in its form modified according to the invention, has been shown to have superior performance, especially with regard to flexural and tensile resilience, which are important characteristics in resisting ballistic impact failure modes, such as: shattering, spalling, bulging and fragmentation following high velocity impact.

Post impact failure modes for OPC cement panels subjected to high-velocity small projectile impact can be observed as: (1) perforation, (2) penetration, (3) bulging, (4) spalling, (5) fragmentation, (6) matrix cracking, (7) delamination, (8) microcracks, and (9) spider-net-like network cracking.

The advantage of using magnesia cement according to the invention, which has been shown by the inventors to have superior flexural and tensile strength compared with OPC cement, has the effect of significantly reducing most of these failure modes (except penetration and perforation) during small projectile impact, where the specimens have comparable thickness. Moreover, the high flexural performance of magnesium cement eliminates the microcracks and ‘spider-net’-like failures seen in the prior art.

Taking advantage of the hitherto unknown properties of magnesium cement in the context of anti-ballistic performance, together with the further enhancement of fibre reinforcement substantially improves the high velocity impact performance of building materials made in accordance with the invention.

The invention provides, among other aspects, a novel formulation for high-velocity impact-resistant magnesium cement building products which are relatively lightweight, thin and mobile, but which have superior anti-ballistic performance.

According to a preferred embodiment, the main magnesium cement binder in this invention is a composition of light burnt magnesium oxide (MgO) powders and a brine of one or more magnesium salts, which may include: magnesium chloride (MgCl₂), magnesium sulphate (MgSO₄) and sodium or potassium phosphate or potassium phosphates or phosphoric acid, and MgO powders and silicon dioxide (SO₂) rich cementitious materials with or without activators in magnesium activated cement.

Although all type of magnesia cements can be adjusted to improve ballistic performance, preferable material properties for the main binder in this invention are given below.

The light burnt magnesia used in this invention is preferably calcined at a temperature between 700° C.-1000° C. with 80%-95% purity with an average particle size less than 45 μm to increase surface area in contact with water in order to accelerate hydration process resulting early high strength. The activity level of magnesium oxide (MgO) powder is within 50%-70%.

In one embodiment, the brine at a 22-33% solid salt concentration is preferred for the ballistic performance of MOC cement. In the case of using the crystal form, magnesium chloride hexahydrate (MgCl₂·6H₂O) crystals are dissolved in the water to form an aqueous solution with desired solid concentration 24 hours prior to use in the cement production.

In another embodiment, the preferable solid content of magnesium sulfate (MgSO₄) in the solution is within the range of 18% to 26%. In the case of using magnesium sulfate heptahydrate (MgSO₄·7H₂O) crystals, the solution is required to be prepared 24 hours ahead of use in the cement production.

In another embodiment, the combination of both of the above brine solutions are used in conjunction with phosphoric acid and/or other additives and phosphates, such as: sodium mono-fluoro phosphates, sodium hexametaphosphate, magnesium phosphates, silane, etc.

The preferred molar ratio range of MgO to magnesium salts is within the range 5 to 11. In this case, magnesium salts means magnesium chloride or magnesium sulphate, or a combination of both.

The preferred water/cement mass ratio according to the invention is 0.35 to 0.6.

In another embodiment, the magnesium activated cement incorporates magnesium oxide powder and silicon dioxide rich cementitious materials, preferably silica fume/micro-silica and ground granulated blast furnace slag (GGBFS). The magnesium silicate hydrated system (M-S-H) binder forms when water is added to the MgO and SiO₂ powders. The activators or additives accelerate the hydration process but produce no significant change in the formation of M-S-H systems.

In other embodiments of the invention, the formulation may include a combination of one or more cementitious/pozzolana industrial by-products, such as: fly ash, microsilica (silica fume) and/or ground granulated blast-furnace slag (GGBS). These tend to enhance the mechanical properties of the cement by reducing water absorption, and consequently the toughness and durability of matrix.

Preferably, Class F fly ash with 45 μm average particle size is added to the composition within the range at 20% or less by mass of dry mix. Silica fume with less than 2 μm average particle size and GGBFS with less than 10 μm average particle size are included in the composition at a weight proportion of between 5-15% by mass of dry mix. If using MAC, a 1:1 molar ratio of MgO:SiO₂ is used.

In an alternative embodiment, a plasticiser or a high strength water reducer may be included in the composition in order to increase the workability of the admixture during production when it is required.

A homogeneous matrix reduces likelihood of delamination and possible cracking between the interface of panel layers which are to be subjected to high velocity impact. Cohesiveness of structural elements makes the matrix stronger. In addition, this provides a simpler and more efficient production line during manufacturing.

In the present invention, one or more fibre combinations are preferably applied to achieve a preferred balance of high and low modulus materials in a homogeneous matrix, so that uniform propagation of compressive and tensile stress waves are achieved where the panel is subjected to the high velocity small projectile impact.

Preferably, said high-modulus fibres are one or more materials selected from the group comprising: carbon fibre, steel fibre, copper fibre, Kevlar, titanium, graphite, and glass fibre staples. Preferably, said low-modulus material are selected from the group comprising: PVA, PP, PE and banana fibre.

In some embodiments, the fine and coarse aggregate include, but are not limited to: river sand, river stone, granites, basalt, blue metals, etc. The quantity and the particle size should be selected in accordance with the mix design and wall panel thickness.

The magnesia cement may also incorporate fillers such as: sawdust, rice husk, perlite, vermiculite, dolomite, alumina, etc, and other additives may include: phosphoric acid, citric acid, phosphates, water repellents, siloxane functional group, and corrosion inhibitors such as sodium monoflurophosphates, sodium polymetaphosphate, sodium nitrates, sodium and potassium chromate, sodium phosphates, etc.

Some examples of magnesia cement and ballistic test results are presented in the following sections. Ballistic tests are performed in simulated gas gun tests and the ballistic tests defined in AS/NZS 2343 and the US Underwriter Laboratory Standard.

Low modulus fibres, such as PVA or PE fibres, exhibit high ultimate tensile strain behaviour that in turn allows significantly improved ductility, along with its high strain hardening behaviour. Hence, inclusion of low modulus fibres in the cement improves the energy absorption capacity of the cement. This will also reduce the crack width of any shattering induced by a projectile and provide the matrix with increasing bridging strength across any fracture. However, low modulus fibres exhibit low ultimate tensile strength.

Thus, a balance of high modulus fibres (or stone chips e.g. granite chips) and low modulus fibres in the cement matrix provides higher toughness and resilience to projectile impact, by enhancing the ability of the cement to absorb the impact energy. During high velocity impact, the penetration resistance directly relates to the tensile strength and the toughness of the specimen while the energy absorption depends on the strain capacity of the cement matrix.

In embodiments of the present invention, it is preferred to incorporate randomly distributed chopped strand fibres to achieve a more homogeneous matrix. However, it is also possible to incorporate e.g. fiberglass meshes as the reinforcement for the panels.

A low-modulus REC-15-polyvinyl alcohol (PVA) fibre with 39 μm diameter and 8-12 mm in length may be used as a low modulus fibre in the cement matrix.

A high modulus copper coated steel fibre (SE) with 0.2 mm diameter and 8-12 mm in length may be used as a high modulus fibre in the cement matrix.

Alternatively, a copper fibre (Cu) with 0.2 mm diameter and 6-8 mm in length may be used as a high modulus fibre in the cement matrix.

Alternatively, a chopped strand glass fibre with 6-12 μm diameter and 6-8 mm in length may be used as a high modulus fibre in the cement matrix.

Alternatively, other fibres can be used to provide the desired high- or low-modulus effect in the cement matrix, such as: polyethylene, polypropylene, carbon, graphite, Kevlar, titanium, etc.

Toughness, i.e. the ability of the cement to absorb energy before failure, is one of the most important properties for impact resistant performance of the material when under projectile impact. It can be represented by the area under the stress/strain curve and therefore, to optimise this property, the strength and strain hardening properties should be balanced.

In preferred embodiments of the invention, steel fibre and/or granite chip coarse aggregate are used in the composition for improving the toughness of the cement matrix.

In an alternative embodiment, natural stone chips, e.g. granite chips, may be used to fully or partially replace the steel as the high modulus fibre, as steel can be subjected to corrosion issues such as concrete cancer later in the service life of the material if it is applied in the magnesium cement without any corrosion protection. Use of these granite chips allows the cement matrix to exhibit comparable impact performance with that of above-described steel fibre reinforcement.

Other inclusions in the matrix may be made for specific purposes. Organic waste fibre, such as rice husk or barley husk, may be included as a lightweight filler; 1-5 mm aluminium oxide grains may be included as an aggregate for enhancing the strength; expanded perlite may be included as a lightweight aggregate; exfoliated vermiculite may be included as a light-weight filler.

### Example—Method of Manufacturing

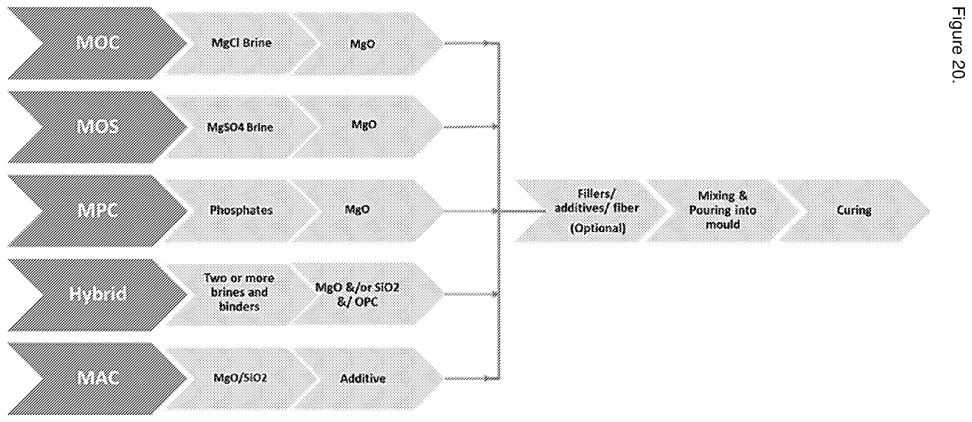

A preferred manufacturing process for anti-ballistic magnesium cement panels according to the invention is presented as follows in the flowchart in FIG. 20, with reference to the material specified in Table 1 below.

TABLE 1
Material Specification

| | | Proportion by wt. % |
|---|---|---|
| Materials | Specification | of Dry mix* |
| Light Burnt Magnesia | Kiln Temperature between 700° C. to | 28.0-35.0 |
| | 1000° C. | |
| | Purity >90% | |
| | Activity 60% to 70% | |
| | CaO <5% | |
| | Ignition <9% | |
| Magnesium Salts: Magnesium | Purity >90% | 10.0-15.0 |
| Chloride Hexahydrate/Magnesium | | |
| Sulfate heptahydrate/Magnesium | | |
| Phosphates | | |
| Fly Ash | Class F-Fly Ash, <45μ | 8.0 to 15.0 |
| Silica Fume | <2μ | 0.0-5.0 |
| Slag | <20μ | 0.0-2.0 |
| Coarse Aggregate (Granite Chips) | 1-20 mm | <50.0 |
| Coarse Aggregate(Aluminium Oxide) | 1-5 mm | 0-5.0 |
| Inert Fillers-Rice Husk | Length: 4 mm | 5.0 to 20.0 |
| | Aspect ratio: 12.5 | |
| | Bulk Density (kg/m3) 295 | |
| | Water absorption (%) 123.7 | |
| Inert Fillers- Expanded Perlite/ | Water Absorption (%) 47 | <20 |
| vermiculite | 1 mm-3 mm | |
| Stapple glass fibres | 6-8 mm length- Alkali coated C-glass | <1.0 |
| PVA-REC15 fibres | 8-12 mm length, 39μ dia | <2.0 |
| Steel Fibres | 8-12 mm length, 0.2 mm dia, Copper | <2.0 |
| | Coated | |
| Phosphoric Acid | 85% concentration | <2.0 |
| Modifier Additives (Sodium | 20%-60% concentration | <2.0 |
| monofluorophosphate, Sodium | | |
| hexametaphosphates, Silane | | |
| Emulsion, Other phosphates, etc.) | | |
| Total Water (including from Brine) to be | Tap water | 28.0-35.0 |
| water/solid powder (w/sp) ratio of 0.3 to | | w/sp - 0.30 to 0.60 |
| 0.6 | | |

Step 1: One or more brines of magnesium salt solution, as described above, with a desired concentration is prepared at least 24 hours ahead of making the composition (if prepared from the crystal form of the salts). The brine temperature should be between 22° C. to 30° C.

Step 2: The brine is added into a mixer, followed by the additives. Adding these ingredients does not change the brine pH which is about 6.5 to 8.0. These are mixed until well dispersed in the solution.

Step 3: The MgO and cementitious materials, fly ash, silica fume and slag, are added together into the alkaline aqueous solution prepared in Step 2 and blended until dispersed well in the mixer. In the case of magnesium activated cement, Step 3 precedes Step 2.

Step 4: The fillers and aggregate, such as reinforcing fibre, rice husk (optionally together with exfoliated perlite and/or vermiculite) and the fine and coarse aggregate described above are added to the mixture prepared in step 3, followed by the chopped strand fibres which are dispersed in the admixture (5 to 10 minutes).

Step 5: The viscosity and the temperature of the paste are checked before placing into moulds which may be temporary formwork or permanent formwork.

Step 6: Once cast in the moulds, the wet samples/products are cured at room temperature with Relative Humidity (RH) between 60% and 70%. The curing temperature should not be less than 20° C. for the first 24-48 hours.

Step 7: The products are demoulded and placed into a 45° C.±3° C. curing room for 3 to 5 hours. In the case of using permanent formwork, the products are placed in the curing room without demoulding.

The mechanical properties of the resulting panels as specified above are measured to be greater than 34 MPa in compressive strength and greater than 10 MPa in flexural strength. The strength tests are performed in accordance with ASTM C0109M-16A and ASTM C348-18 respectively.

Alternative example compositions for the protective magnesium oxide cement matrix according to the invention are shown in table 2 below.

TABLE 2
Example Compositions

| | Composition Proportion | | | |
|---|---|---|---|---|
| | by weight of dry mix (%) | | | |
| | Exam- | Exam- | Exam- | Exam- |
| Components | ple 1 | ple 2 | ple 3 | ple 4 |
| Light burnt Magnesia | 31.0 | 41.6 | 39.8 | 51.4 |
| Magnesium Salt | 10.4 | 11.8 | 11.3 | 17.1 |
| Cementitious materials - | | | | |
| Fly Ash | 11.6 | 12.5 | 11.9 | 15.4 |
| Silica Fume | 3.9 | 1.3 | 2.0 | 1.5 |
| GGBFS | 0.9 | 1.3 | 1.2 | 1.5 |
| Fillers: Rice Husk/Perlite/ | 7.1 | 5.3 | 5.0 | 5.5 |
| Vermiculite) | | | | |
| Aggregates -Granite Chips | 31.0 | 16.0 | 24.0 | 0.0 |
| Filler (Aluminum Oxide | 1.2 | 1.7 | 1.6 | 1.5 |
| Powder) | | | | |
| Fibers: (Vol fraction, V_{f} %) | | | | |
| PVA | 1.0 | 1.1 | 1.1 | 1.1 |
| Glass Fiber | 0.1 | 0.1 | 0.1 | 0.04 |
| Steel | 0.0 | 0.4 | 0.0 | 0.3 |
| Phosphates/Phosphoric | 1.3 | 1.8 | 1.3 | 0.8 |
| Acid/Additives | | | | |
| Water of dry weight of the | 32.5 | 32.9 | 32.0 | 36.5 |
| composition | | | | |

The properties of some examples of cement specimens according to the invention are in the range of 40 MPa to 70 MPa and 12 MPa to 19 MPa in compressive and flexural strength respectively, as shown in table 3 below.

TABLE 3
Mechanical properties of specimens.

| | Compressive | Flexural Strength |
|---|---|---|
| Sample ID | Strength (MPa) | (MPa) |
| Sample 1.0 | 34.9 | 12.0 |
| Sample 2.1 | 41.4 | 12.3 |
| Sample 2.2 | 40.1 | 19.1 |
| Sample 3.0 | 41.7 | 13.7 |
| Sample 4.1 | 43.4 | 17.0 |
| Sample 4.2 | 41.2 | 13.0 |

| | | Direct Tensile Strength (MPa) |
|---|---|---|
| Specimens | MOE (MPa) | (at Strain rate (1 × 10⁻⁹) |
| 1 | 30903 | 3.06 |
| 2 | 29182 | 3.01 |
| 3 | 39190 | 3.06 |
| Average | 33092 | 3.00 |

After immersion in water for 24 hours, the water absorption of the specimens is within the range of 0.2% to 0.5% and retention of both compressive and flexural strengths are in the range of 80% to 110%, i.e., some compositions show an increase in strength underwater.

### High Velocity Impact Testing

The test regime includes two parts:
A high velocity 12 mm diameter steel ball projectile impact test; and
Ballistic impact tests that comply with the AS/NZS 2343 and US: Underwriter Laboratory Standard.

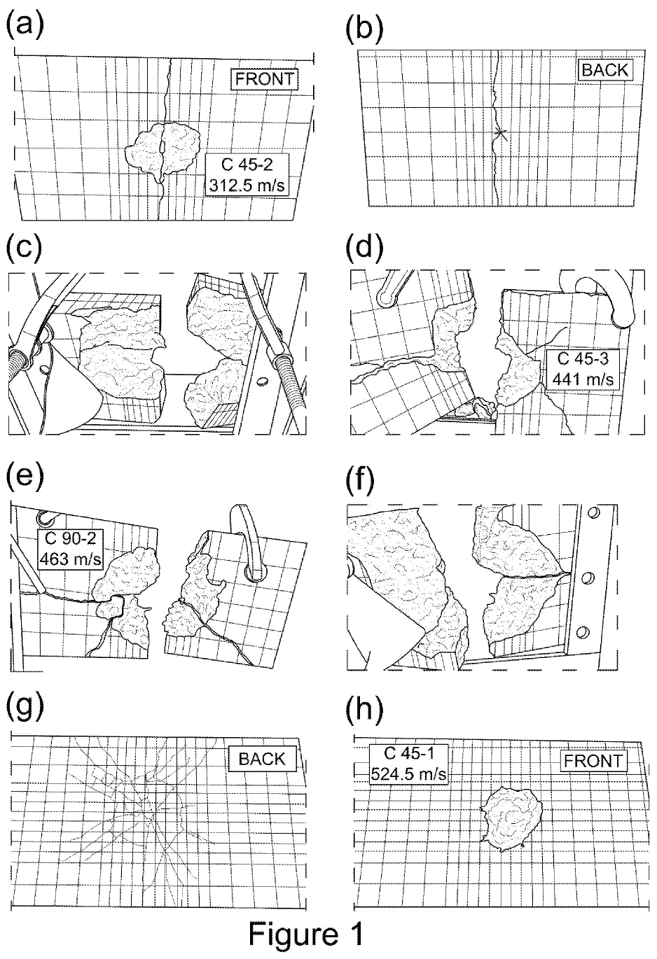

The inventors have observed that 40 grade INEX magnesium cement panel according to the invention exhibits excellent flexibility under impact from a 30-30 Winchester bullet with an impact energy of 2329 J. A target panel having a thickness of only 19 mm shows very little scabbing and spalling after perforation by the bullet and a large intact area is evident. A 50 mm thick OPC panel was shattered after a small projectile impact with an impact energy of 730 J, per FIG. 1.

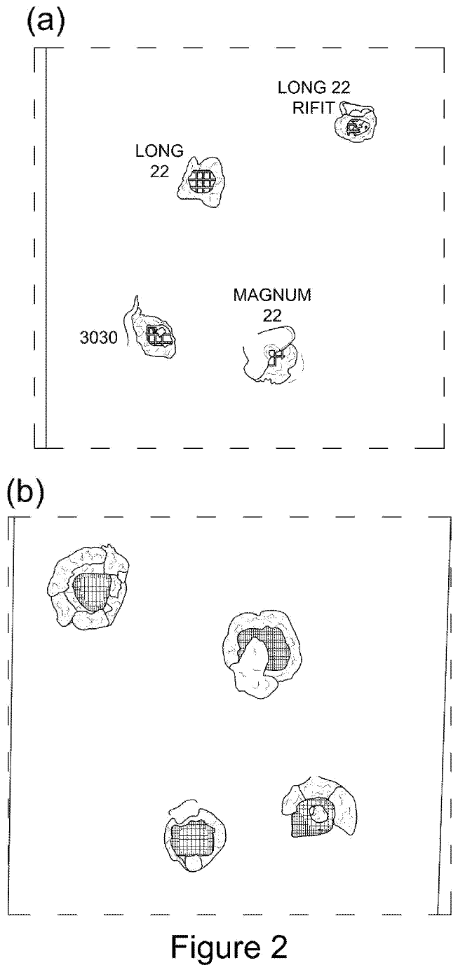

A 19 mm thickness of 40-grade high flexural thin non-ballistic INEX magnesium cement panel, when subjected to a ballistic impact exhibits high flexibility and tensile strength of the matrix by observing small local failure with large intact at both impact and rear surfaces, see FIG. 2.

The INEX 19 mm specimens, subjected to the impact of 0.22 Long Rifle with a 40 gr (2.6 g) bullet with an impact velocity of about 317 m/s that generated an impact energy of 179 J, exhibits no penetration. Being a sandwich structure with layered fiberglass reinforcement, some spalling occurs at the rear surface.

Post-failure observation of the INEX 19 mm specimens subjected to the impact of a 0.22 Magnum Rifle, 40 gr (2.6 g), and 3030 Winchester shows that both impacts caused perforation through the specimens with the impact energy of 439 J and 2390 J respectively. The higher impact of 3030 Winchester causes larger scabbing and spalling damage including to the outermost fiberglass layers. However, no radial cracks were observed surrounding of the damage, and there were large intact surfaces at both sides as shown in FIG. 2.

In preferred embodiments of the invention, the inventors have further enhanced the flexibility and compressive strength of magnesium cement by incorporating a distributed combination of one or more fibre reinforcement materials in the matrix. Hence, the resistance to propagation of compressive and tensile stresses resulting from high velocity impact has been improved.

In this invention, a hybrid combination of fibres such as PVA, PP, PE, carbon fibre, Steel fibre, copper fibre, and Glass fibre staples, has been used to achieve the balance of high and low modulus fibres.

One of the important results of preferred embodiments of this invention is to improve the toughness of the magnesium cement product, to make it flexible rather than brittle, and hence more likely to absorb impact energy before perforation failure occurs. For this purpose, steel fibre and/or granite chips have been incorporated in the magnesium cement matrix.

Granite chips may also be used as an alternative to high modulus steel or copper fibres for improving resistance to high velocity impact.

Therefore, with the improvement in flexibility and toughness of the magnesium cement according to the invention, the modified magnesium cement panels according to the invention exhibit remarkably high ballistic resistance, in the range of thickness 44 mm-110 mm under 1850 kg/m³. The inventive panels withstand different levels of ballistic impact up to impact energy of 3400 J, as per NATO R² level in accordance with AS/NZS 2343-1997 and Level 8 of the US-underwriter Laboratory Standard (UL).

The following ballistic impact tests complied with AS/NZS 2343 and US Underwriter Laboratory Standard.

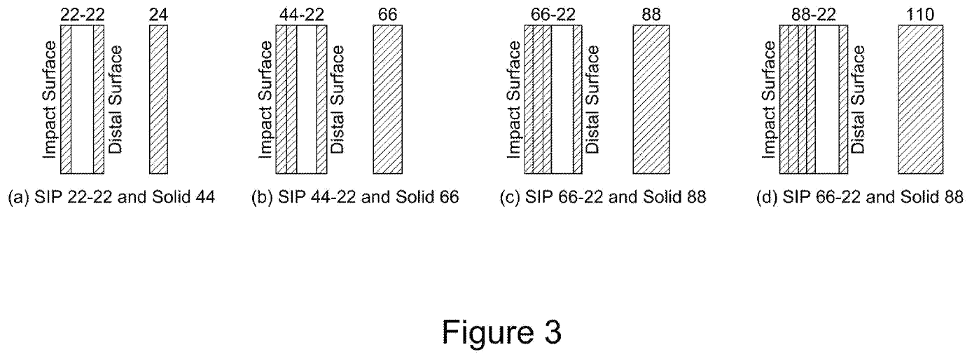

The magnesium cement test specimens were manufactured according to the method above. They were subjected to high velocity impact tests in various formats, including various thicknesses and configurations, such as solid forms, solid laminated forms, and SIP panels. Some examples of specimens are as illustrated in FIG. 3.

Where tested as thin solid panels, 2 or more panels of the preferred inventive material are laminated together—e.g. ‘2×22’ refers to 2 panels of 22 mm thickness panels that are fixed together without a gap.

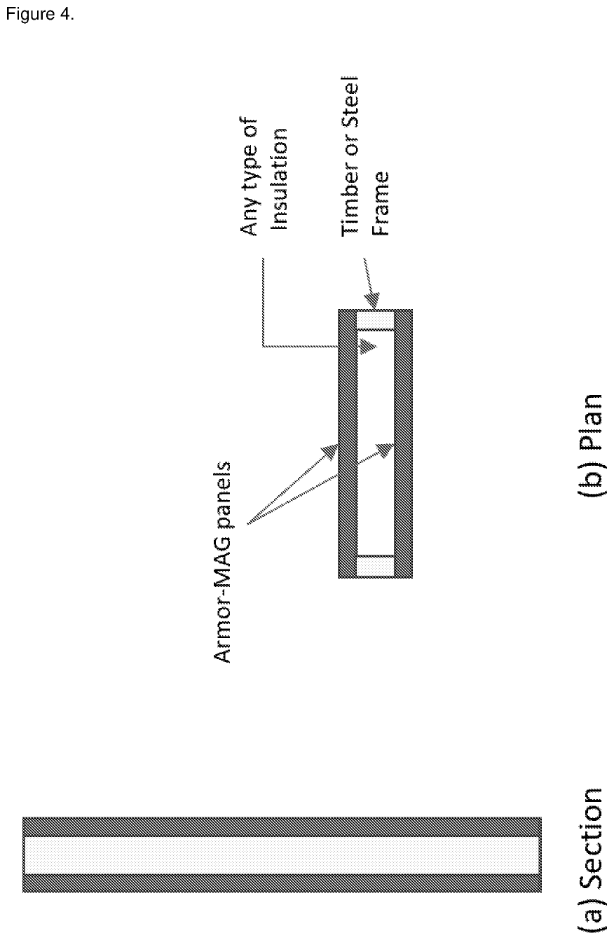

SIP panels according to this invention are formed like a cladding wall system, in which one or more 22 mm thick panels are separated by a steel or timber frame, which includes a gap of between 70 mm or 90 mm between the panels. Insulation material may be filled inside this gap when in use as a building material, as shown in FIG. 4.

Panels with the thickness from 13 mm to 50 mm, solid layers from 2×22, 3×18, 3×22, 4×22, and SIP panels with 22-22 (22 mm impact panels separated from a 22 mm distal panel) to 88-22 (a laminate of 4×22 mm impact panels separated from a 22 mm distal panel) were tested.

### 1. High Velocity 12 mm Diameter Steel Ball Projectile Impact Test

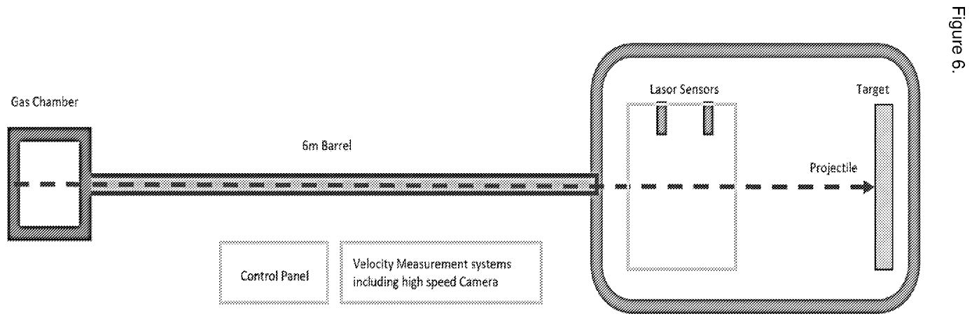

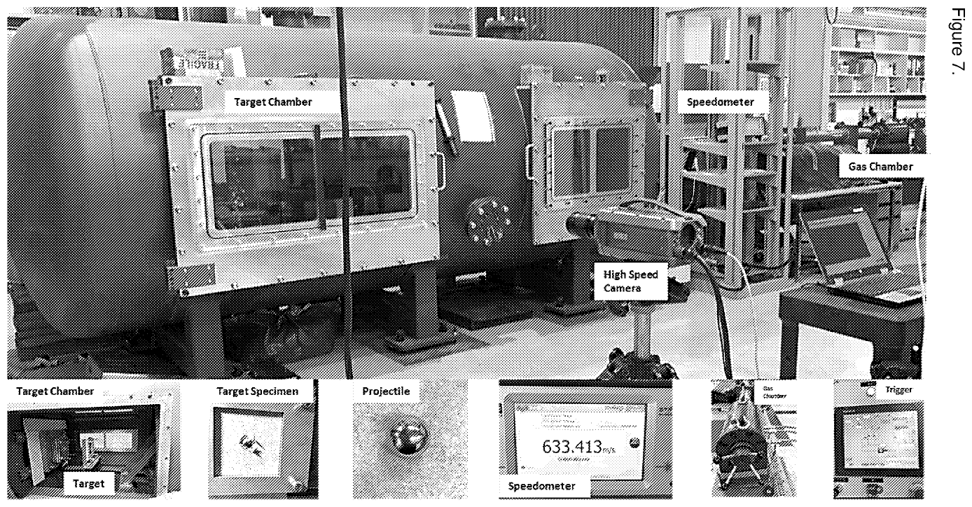

High-velocity small projectile impacts are conducted with a gas gun with a single barrel. The 12 mm diameter steel ball projectile with 7.05 g mass were propelled by compressed helium gas to achieve the impact velocities in the range of 400 m/s to 815 m/s. The gas gun test set-up is illustrated in FIG. 6 and FIG. 7.

The impact test data are presented in Table 4 below, wherein the panels according to the invention are referred to as ‘Armor-MAG’.

TABLE 4
High velocity small projectile impact test results

| | | | | | | | | |
|---|---|---|---|---|---|---|---|---|
| | | Impact Velocity | Impact Velocity | Residual Velocity | Penetration | Energy | | Energy |
| | Thickness | (m/s, measured | (m/s, from high- | (m/s, from high- | Depth | Absorption | Toughness | Absorption |
| Test Name | (mm) | by sensors) | speed video) | speed video) | mm) | (J) | kJ/m3 | (J/mm) |

Amor-MAG Solid Panels

| | | | | | | | | |
|---|---|---|---|---|---|---|---|---|
| MBT 13 | 13 | 406.1 | 405.1 | 300.6 | 13 | 259.9 | 453.3 | 20.0 |
| BT5 13 | 13 | 414.1 | 410.4 | 287.8 | 13 | 301.7 | 526.2 | 23.2 |
| HB 18 | 18 | 416.0 | 413.6 | 235.9 | 18 | 406.9 | 512.6 | 22.6 |
| MBT 18 | 18 | 415.4 | 412.7 | 231.9 | 18 | 410.9 | 517.6 | 22.8 |
| BT4 18 | 18 | 413.2 | 409.6 | 242.5 | 18 | 384.2 | 484.0 | 21.3 |
| BT1 18 | 18 | 413.9 | 410.4 | 241.6 | 18 | 387.9 | 488.7 | 21.6 |
| BT6 22 | 22 | 412.8 | 409.3 | 212.9 | 22 | 430.6 | 443.9 | 19.6 |
| BT9 22 | 22 | 419.1 | 416.9 | 244.4 | 22 | 402.0 | 414.3 | 18.3 |
| BT6g 22 | 22 | 421.7 | 418.7 | 223.8 | 22 | 441.3 | 454.9 | 20.1 |
| BT6 22 | 22 | 420.4 | 417.9 | 221.2 | 22 | 443.3 | 456.9 | 20.1 |
| BT3 36 | 36 | 414.7 | 412.2 | 36.2 | 36 | 594.3 | 374.3 | 16.5 |
| BT1 36 | 36 | 414.5 | 412.2 | 33.4 | 38 | 595.0 | 374.8 | 16.5 |
| BT2 36 | 36 | 418.4 | 417.9 | 46.9 | 36 | 607.8 | 382.8 | 16.9 |
| BT3 36 | 36 | 419.1 | 417.9 | 44.2 | 36 | 608.6 | 383.4 | 16.9 |
| BT6 36 | 36 | 418.8 | 416.9 | 39.8 | 36 | 606.9 | 382.3 | 16.9 |
| BT6g 36 | 36 | 416.0 | 413.6 | 44.3 | 36 | 596.1 | 375.5 | 16.6 |
| MBT 36 | 36 | 501.6 | 497.5 | 109.3 | 36 | 830.2 | 522.9 | 23.1 |
| BT4 36 | 36 | 500.0 | 497.5 | 125.1 | 36 | 817.2 | 514.7 | 22.7 |
| MBT 50 | 50 | 633.4 | 698.3 | 270.5 | 50 | 1460.7 | 662.4 | 29.2 |
| MBT 50 | 50 | 700.5 | 703.6 | 260.2 | 50 | 1506.2 | 683.1 | 30.1 |
| BT1 50 | 50 | 682.6 | 698.2 | 294.3 | 50 | 1413.3 | 640.9 | 28.3 |
| BT6 50 | 50 | 554.4 | 703.9 | 289.3 | 50 | 1451.5 | 658.3 | 29.0 |
| BT7G 50 | 50 | 719.4 | 711.3 | 304.0 | 50 | 1457.5 | 661.0 | 29.1 |
| BT9 50 | 50 | 697.5 | 703.9 | 387.0 | 50 | 1218.7 | 552.7 | 24.37 |

Amor-MAG Solid Layer Panels

| | | | | | | | | |
|---|---|---|---|---|---|---|---|---|
| HB 3X18 | 54.0 | 733.9 | 724.2 | 68.2 | 54.0 | 1832.3 | 769.42 | 33.9 |
| BT6 3X22 | 66.0 | 811.4 | 806.7 | 249.0 | 66.0 | 2075.1 | 712.96 | 31.4 |
| BT6 4X22 | 88.0 | 816.3 | 812.1 | 0.0 | 56.0 | 2324.5 | 598.98 | 41.5 |
| BT6g 4X22 | 88.0 | 816.3 | 812.1 | 0.0 | 60.0 | 2324.5 | 598.97 | 38.74 |

Amor-MAG SIP Panel System

| | | | | | | | | |
|---|---|---|---|---|---|---|---|---|
| BT1 18-18 | 36.0 | 500.9 | 497.5 | 146.0 | 36.0 | 797.2 | 502.17 | 22.1 |
| BT6 22-22 | 44.0 | 729.9 | 718.6 | 293.0 | 44.0 | 1517.9 | 782.26 | 34.5 |
| BT6 44-22 | 66.0 | 808.1 | 803.4 | 234.6 | 66.0 | 2081.2 | 715.04 | 31.5 |
| MPT 36-18 | 54.0 | 733.9 | 724.2 | 205.9 | 54.0 | 1699.1 | 713.50 | 31.47 |

Amor-MAG Solid Panels- No Perforation

| | | | | | | | | |
|---|---|---|---|---|---|---|---|---|
| MBT 36 | 36.0 | 411.7 | 409.3 | 0.0 | 25.0 | 590.7 | 372.04 | 23.6 |
| BT4 36 | 36.0 | 417.1 | 415.7 | 0.0 | 25.0 | 609.3 | 383.76 | 24.4 |
| BT7G 36 | 36.0 | 421.5 | 417.9 | 0.0 | 18.0 | 615.7 | 387.83 | 34.2 |
| MBT 50 | 50.0 | 414.7 | 412.2 | −7.9 | 18.0 | 598.7 | 271.51 | 33.3 |

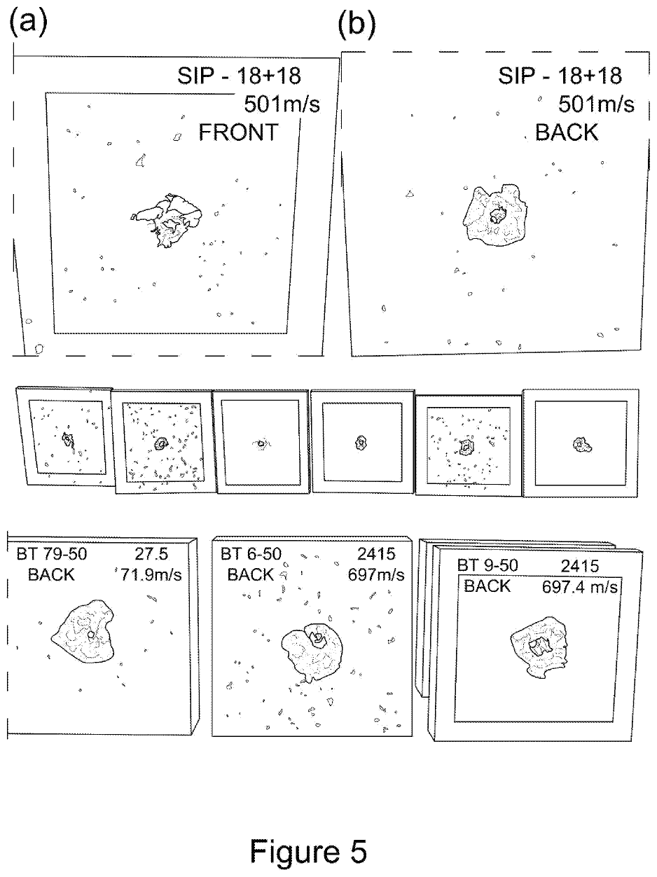

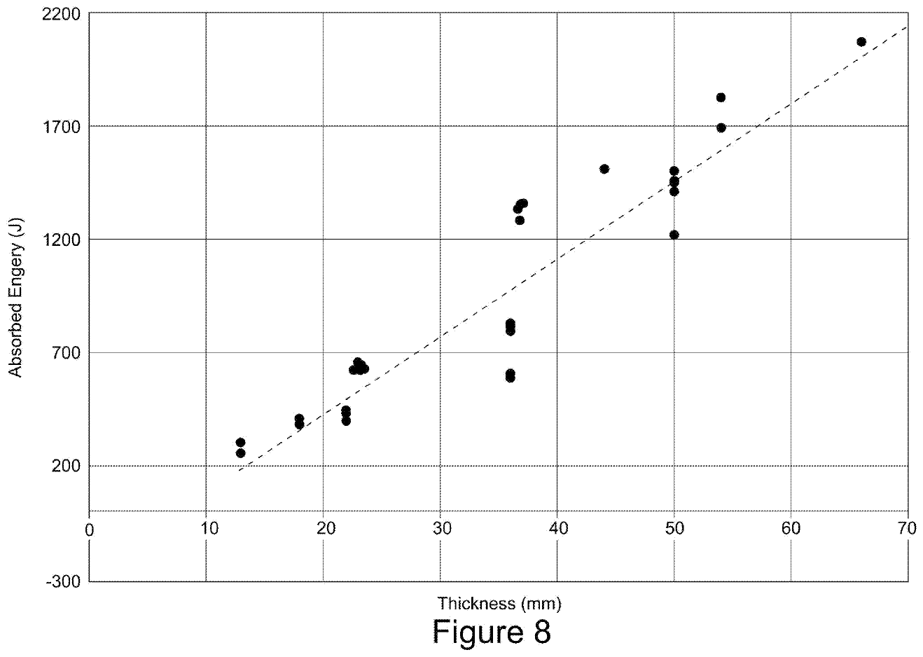

As shown in FIG. 8, the maximum energies absorbed by the panels at the perforation failure point (with small scabbing and spalling area, as shown in FIG. 5), are within 400 J to 500 J for the <22 mm panel thickness. The absorbed energy for the 36 mm, 50 mm and 66 mm panels were within the range 600 J-830 J, 1200 J-1500 J and >2000 J respectively.

The impact toughness of the material depends on both thickness and impact velocity, in addition to the innate high compressive and flexural strength of the material according to the invention. When impact speed is higher, the compression strain waves propagate faster to the edge of the specimen while the projectile tends to perforate through the thickness of the specimens.

When the projectile hits the surface of the specimen, a compressive wave is generated across the impact surface and through the corresponding depth of the specimen. Later those waves transform into a tensile stress wave near to the distal surface. The tensile wave leads to the periphery of the specimen pushing outward until it breaks when the residual energy of the projectile, after travelling along the depth of the specimen, is still sufficient to do so. This is called perforation failure.

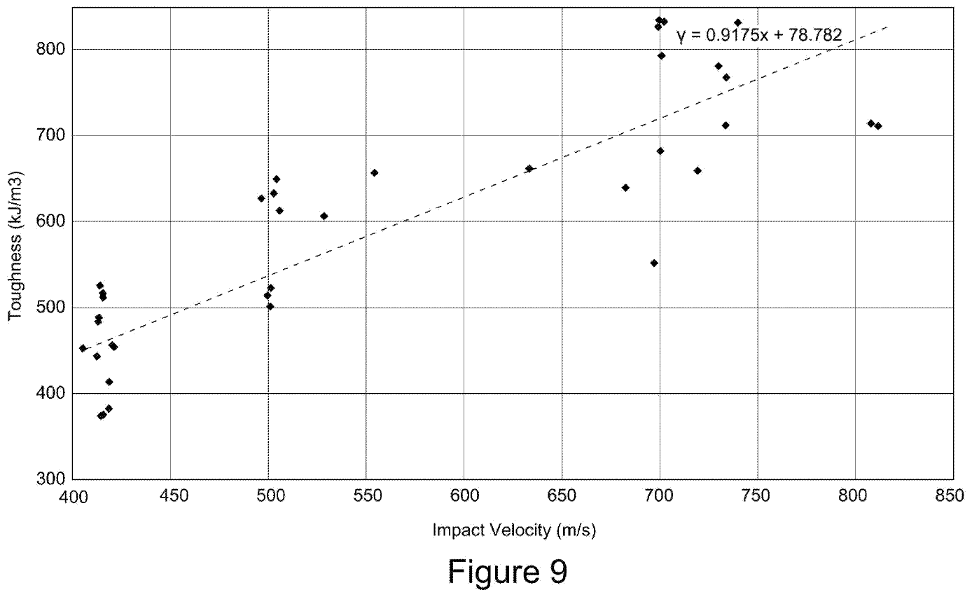

As shown in FIG. 9, the panels, less than 22 mm thickness, subjected to an impact velocity of 400 m/s-420 m/s shows a toughness rating within 400 kJ/m³ to 520 kJ/m³. The toughness rating of the 36 mm thick panels is 380 kJ/m³ and 520 kJ/m³ with an impact velocity of 410 m/s and 500 m/s respectively. When the panel thickness is 50 mm, the toughness rating is within the range of 600 kJ/m³-800 kJ/m³ at impact velocities of between 500 m/s and 800 m/s.

Tables 5a, 5b and 5c sets out the results of the ballistic tests for each of the solid and SIP panels according to the invention. Table 5a shows the results for the panels without permanent formwork while Table 5b presents the results for the panels with 0.55 bmt colour-bond permanent formwork. Table 5c represents the ballistic performance of joint system of the walls with the MgO board blocker as thin as 19 mm. It will be seen that each panel passed the required test to be used as an anti-ballistic panel.

TABLE 5a
Ballistic Test Result of Armor-MAG Panels without permanent formwork.
Ballistics Test Results of Armor MAG Panels

| | Solid Panel | SIP Panel | | | | | | | |
|---|---|---|---|---|---|---|---|---|---|
| | Thickness | Thickness | | | Threat | Avg. Impact | Avg. Impact | Numbers | |
| Test | (mm) | (mm) | Test Conditions | Standards | Class | Speed m/s | Energy J | of Shots | Notes |
| 1 | 44 | 22-22 | Calibre 0.357 Mag SJFN | AS/NZS 2343 | G1 | 462 | 1090 | 3 | Pass |
| | | | wt 158 gr (nominal) | | | | | | |
| | | | Barrel Length 10 in | | | | | | |
| | | | 450 +/− 15 m/s | | | | | | |
| 2 | 66 | 44-22 | Calibre 0.44 Mag SJSP | AS/NZS 2343 | G2 | 492 | 1884 | 3 | Pass |
| | | | wt 240 gr (nominal) | | | | | | |
| | | | Barrel Length 10 in | | | | | | |
| | | | 480 +/− 15 m/s | | | | | | |
| 3 | 44 | 22-22 | Calibre 12Gauge SG Shot | AS/NZS 2343 | S0 | 407 | 2637 | 2 | Pass |
| | | | wt 32 gram | | | | | | |
| | | | Barrel Length 30 in | | | | | | |
| | | | 400 +/− 20 m/s | | | | | | |
| 4 | 66 | 44-22 | Calibre 12 Gauge70 mm SG Slug | AS/NZS 2343 | S1 | 454 | 2915 | 2 | Pass |
| | | | wt 1 oz | | | | | | |
| | | | Barrel Length 26 in | | | | | | |
| | | | 450 +/− 20 m/s | | | | | | |
| 5 | 88 | 66-22 | Calibre 7.62 × 51 mm FMJ M80 | AS/NZS 2343 | NATO | 851 | 3447 | 3 | Pass |
| | | | wt 147 gr (nominal) | | | | | | |
| | | | Barrel Length 24 in | | | | | | |
| | | | 838 +/− 15 m/s | | | | | | |
| 6 | 88 | 66-22 | Calibre 7.62 × 39 mm FMJ MSC | — | AK47 | 729 | 2106 | 3 | Pass |
| | | | wt 123 gr (nominal) | | | | | | |
| | | | Barrel Length 20 in | | | | | | |
| | | | 726 +/− 15 m/s | | | | | | |
| 7 | 88 | 66-22 | Calibre 5.56 × 45 mm FMJ SS109 | — | F88 | 937 | 1761 | 3 | Pass |
| | | | wt 62 gr (nominal) | | | | | | |
| | | | Barrel Length 24 in | | | | | | |
| | | | 922 +/− 15 m/s | | | | | | |
| 8 | 44 | 22-22 | Calibre 44Magnum LSWC GC | US UL752 | Level 3 | 412 | 1323 | 1 | Pass |
| | | | wt 240 gr (nominal) | | | | | | |
| | | | Barrel Length 6 in | | | | | | |
| | | | 411-452 m/s | | | | | | |
| 9 | 66 | 44-22 | Calibre 5.56 × 45 mm FMJ M193 | US UL752 | Level 7 | 969 | 1677 | 1 | Pass |
| | | | wt 55 gr (nominal] | | | | | | |
| | | | Barrel Length 24 in | | | | | | |
| | | | 939-1033 m/s | | | | | | |
| 10 | 110 | 88-22 | Calibre 308 Winch. FMJ M80 | US UL752 | Level 8 | 849 | 3510 | 3 | Pass |
| | | | wt 150 gr (nominal) | | (NATO) | | | | |
| | | | Barrel Length 24 in | | | | | | |
| | | | 838-922 m/s | | | | | | |

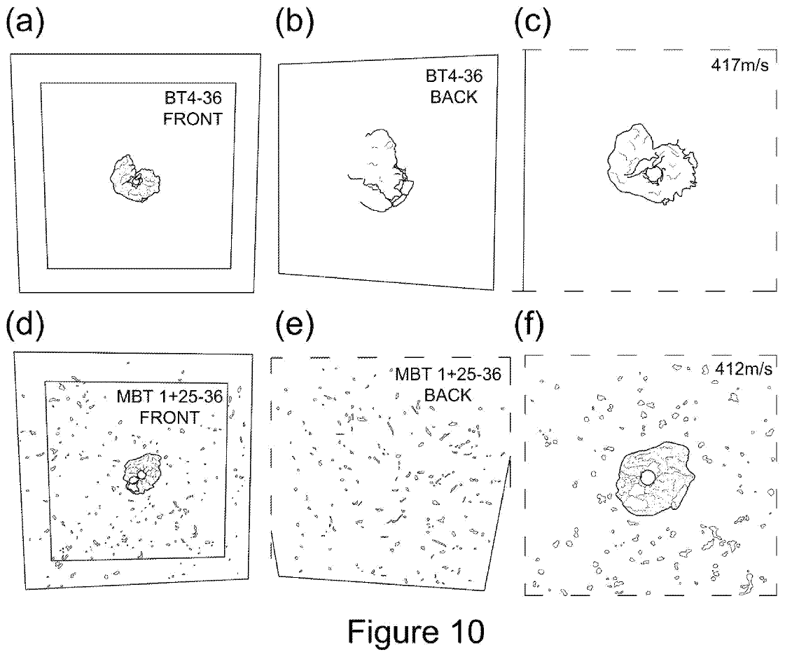

FIG. 10 shows photographs of post-failure modes for 36 mm solid panels with and without steel fibre reinforcement according to the invention. Views (a), (b) and (c) show, respectively, the front impact surface, the distal surface and the embedded non-ricochet bullets after the impact on specimens with no steel fibre. Views (d), (e) and (f) show, respectively, the front impact surface, the distal surface and the embedded non-ricochet bullets after the impact on specimens with steel fibres, according to the invention.

The ballistic limit, which is the impact energy or speed just before perforation failure of the specimen, of the 36 mm panel including steel fibres is 412 m/s, whereas it is 417 m/s for the panel excluding steel fibres. The bulging mode at the distal surfaces as shown in FIGS. 10(b) and (e). The panel according to the invention absorbed 591 J and the panel without steel fibre inclusion absorbed 609 J. In respect of the impact toughness, the specimens without steel fibre inclusion with 276 kJ/m³ is slightly higher than the sample with steel fibre inclusion at 268 kJ/m³.

TABLE 5(b)
Ballistic Test Result of Armor-MAG Panels with 0.55 bmt Colour-bond Permanent Formwork
Ballistics Test Results of Armor-MAG Panels with 0.55 BMT Color-bond Permanent Formwork

| | Solid Panel | SIP Panel | | | | | | | |
|---|---|---|---|---|---|---|---|---|---|
| | Thickness | Thickness | | | Threat | Avg. Impact | Avg. Impact | Numbers | |
| Test | (mm) | (mm) | Test Conditions | Standards | Class | Speed m/s | Energy J | of Shots | Notes |
| 1 | 44 | 22-22 | Calibre 9 mm FMJ RN MK.2Z | AS/NZS 2343 | G0 | 416 | 646 | 3 | Pass |
| | | | wt 115 gr (nominal) | | | | | | |
| | | | Barrel Length 10 in | | | | | | |
| | | | 405 +/− 15 m/s | | | | | | |
| 2 | 44 | 22-22 | Calibre 0.357 Mag SJFN | AS/NZS 2343 | G1 | 452 | 1047 | 3 | Pass |
| | | | wt 158 gr (nominal) | | | | | | |
| | | | Barrel Length 10 in | | | | | | |
| | | | 450 +/− 15 m/s | | | | | | |
| 3 | 44 | 22-22 | Calibre 12Gauge SG Shot | AS/NZS 2343 | S0 | 406 | 2637 | 2 | Pass |
| | | | wt 32 gram | | | | | | |
| | | | Barrel Length 30 in | | | | | | |
| | | | 400 +/− 20 m/s | | | | | | |
| 4 | 50 | 25-25 | Calibre 0.44 Mag SJSP | AS/NZS 2343 | G2 | 479 | 1786 | 3 | Pass |
| | | | wt 240 gr (nominal) | | | | | | |
| | | | Barrel Length 10 in | | | | | | |
| | | | 480 +/− 15 m/s | | | | | | |
| 5 | 50 | 25-25 | Calibre 12 Gauge70 mm SG Slug | AS/NZS 2343 | S1 | 447 | 2832 | 2 | Pass |
| | | | wt 1 oz | | | | | | |
| | | | Barrel Length 26 in | | | | | | |
| | | | 450 +/− 20 m/s | | | | | | |
| 6 | 55 | 25-25 | Calibre 5.56 × 45 mm | AS/NZS 2343 | R1 | 973 | 1687 | 3 | Pass |
| | | | wt 55 er(norminal} | | | | | | |
| | | | Barrel Length 24 in | | | | | | |
| | | | 980 +/− 15 m/s | | | | | | |
| 7 | 50 | 25-25 | Calibre 12 Gauge70 mm SG Slug | AS/NZS 2343 | S1 | 447 | 2832 | 2 | Pass |
| | | | wt 1 oz | | | | | | |
| | | | Barrel Length 26 in | | | | | | |
| | | | 450 +/− 20 m/s | | | | | | |
| 8 | 88 | 66-22 | Calibre 7.62 × 51 mm FMJ M80 | AS/NZS 2343 | NATO | 849 | 3433 | 3 | Pass |
| | | | wt 147 gr (nominal} | | | | | | |
| | | | Barrel Length 24 in | | | | | | |
| | | | 838 +/− 15 m/s | | | | | | |
| 9 | 70 | 35-35 | Calibre 7.62 × 51 mm FMJ M80 | AS/NZS 2343 | NATO | 838 | 3349 | 3 | Pass |
| | | | wt 147 gr (nominal) | | | | | | |
| | | | Barrel Length 24 in | | | | | | |
| | | | 838 +/− 15 m/s | | | | | | |
| 10 | 44 | 22-22 | Calibre 44Magnum LSWC GC | US UL752 | Level 3 | 444 | 1532 | 1 | Pass |
| | | | wt 240 gr (nominal) | | | | | | |
| | | | Barrel Length 6 in | | | | | | |
| | | | 411-452 m/s | | | | | | |

TABLE 5(c)
Ballistic Test Result for Armor-MAG Panel Joint Systems with 0.55 mm bmt Colour-bond Permanent Formwork
Ballistics Test Results of Armor-MAG Panel Joint Systems with 0.55 BMT color-bond Permanent Formwork

| | Wall System | | | | | | | | |
|---|---|---|---|---|---|---|---|---|---|
| | Nominal | SIP Panel | | | | | | | |
| | Thickness | Thickness | | | Threat | Avg. Impact | Avg. Impact | Numbers | |
| Test | (mm) | (mm) | Test Conditions | Standards | Class | Speed m/s | Energy J | of Shots | Notes |
| 1 | 77 | 25-25 | Calibre 12 Gauge70 mm SG Slug | AS/NZS | S1 | 461 | 3012 | 2 | Pass |
| | | | wt 1 oz | 2343 | | | | | |
| | | | Barrel Length 26 in | | | | | | |
| | | | 450 +/− 20 m/s | | | | | | |
| 2 | 70 | 22-22 | Calibre 44Magnum LSWC GC | US UL752 | Level 3 | 447 | 1555 | 1 | Pass |
| | | | wt 240 gr (nominal) | | | | | | |
| | | | Barrel Length 6 in | | | | | | |
| | | | 411-452 m/s | | | | | | |

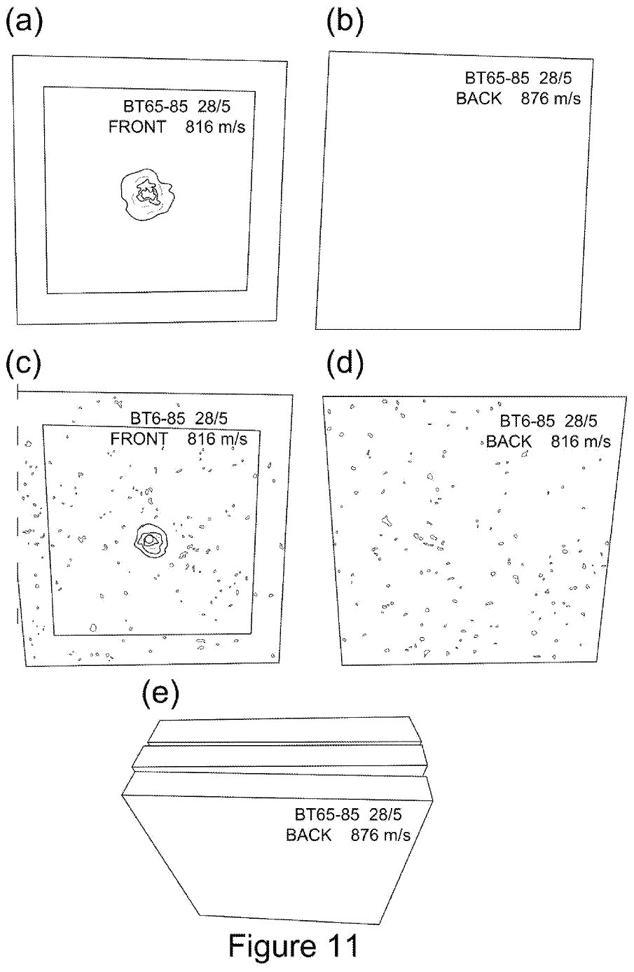

The 4×22 solid layers of panels according to the invention subjected to an impact velocity of 816 m/s with the impact energy of 2350 J are observed to sustain no perforation and the specimens without steel fibre showed higher resistance with an intact distal surface as shown in FIG. 11.

Ballistic impact tests complied with the AS/NZS 2343 and US: Underwriter Laboratory Standard, as set out in tables 6 and 7 respectively.

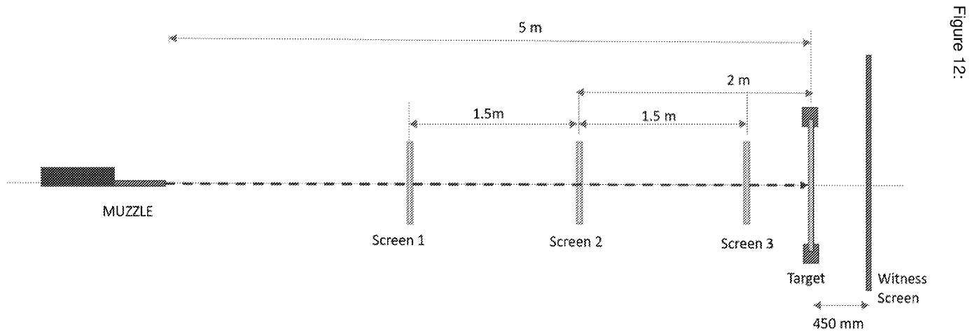

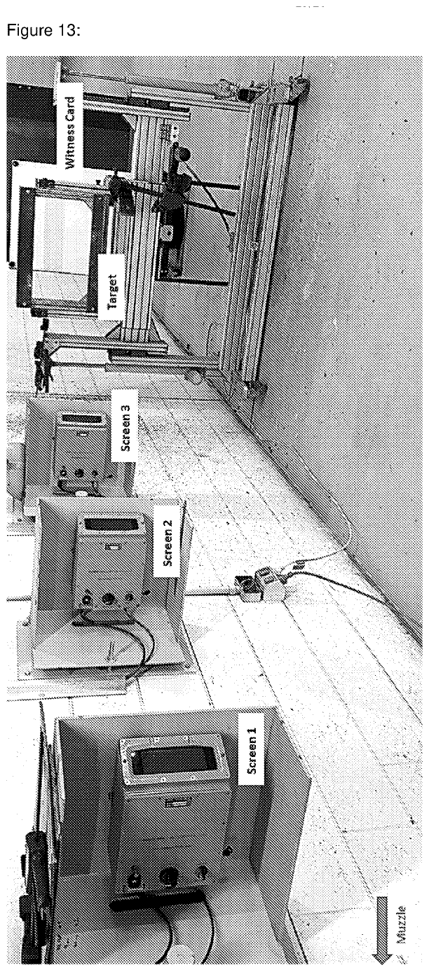

The inventive panel specimen configurations are as shown in FIG. 3 and FIG. 4. The ballistic test set-up schematic diagram and figure are as shown in FIG. 12 and FIG. 13.

TABLE 6
Ballistic Test Condition- Table B1 - AS/NZS 2342-1997

| | | | Measured velocity | | | |
|---|---|---|---|---|---|---|
| Classification* | | | within 2.5 m | Minimum | Number | Pattern of Strikes |
| of panel or | | Ammunition | of target (m/s) | range (m) | of | (for flat Panels) |
| element | Calibre | (see Note 1) | (see Note 2) | (see Note 3) | Strikes | (see Note 4 and 5) |
| Class G0 | 9 mm military | Mk 2Z standard 9 mm | 405 ± 15 | 3 | 3 | Shot centres 100 mm, (±10, −0 |
| | parabellum | 7.4 g metal case bullet | | | | mm) apart forming an equilateral |
| Class G1 | 357 Magnum | 10.2 g soft point semi- | 450 ± 15 | 3 | 3 | triangle within a square of 200 |
| | | jacketed, flat nose | | | | mm per side centrally located on |
| Class G2 | .44 Magnum | 15.6 g soft point semi- | 480 ± 15 | 3 | 3 | panel |
| | | jacketed, flat nose | | | | |
| Class R1 | 5.56 mm | M193 5.56 mm 3.6 g full | 980 ± 15 | 10 | 3 | Shot centres 100 mm, (±10, −0 |
| | | metal case bullet | | | | mm) apart forming an equilateral |
| Class R2 | 7.62 mm | NATO standard 7.62 mm | 850 ± 15 | 10 | 3 | triangle within a square of 200 |
| | | 9.3 g full metal case | | | | mm per side centrally located on |
| | | bullet | | | | panel |
| Class S0 | 12 gauge | 12 gauge 70 mm high | 400 ± 20 | 3 | 2 | Shot centres 100 mm, (±20, −0 |
| | (full choke) | velocity magnum 32 g | | | | mm) apart within a square of |
| | | SG shot | | | | 200 mm per side centrally |
| Class S1 | 512 gauge | 12 gauge 70 mm 28.35 g | 450 ± 20 | 3 | 2 | located on panel |
| | (full choke) | single slug | | | | |
| SPECIAL CLASS | — | — | — | — | — | — |
| (see Note 6) | | | | | | |

*Class G - simulated attack by handgun. Class R - simulated attack by rifle. Class S - simulated attack by shotgun.
Notes:
1. Projectile [symbol] shall be within 2% of nominal mass.
2. If a test satisfies the requirements at velocities greater than that in the Table, it is deemed to pass.
3. Range is the distance from the muzzle to the panel or element
4. If a test satisfies the requirements at shot centres less than the minimum, it is deemed to pass.
5. For other elements, see Clause 6.2.3.
6. Special Class covers protection other than the preceding classes. Calibre, ammunition and other details shall be specified by user or manufacturer as appropriate. [symbol]
indicates data missing or illegible when filed

According to the test conditions, if the bullet, or fragments thereof, damage the witness card during the impact, the test is failed. The test is passed only when no perforation of the panel by the bullet or no damage to witness card occurs during the impact.

Panels made according to the invention with a thickness of less than 110 mm have passed the highest ballistic threat classification of Class R2—NATO (AS/NZS2343) or UL Level 8.

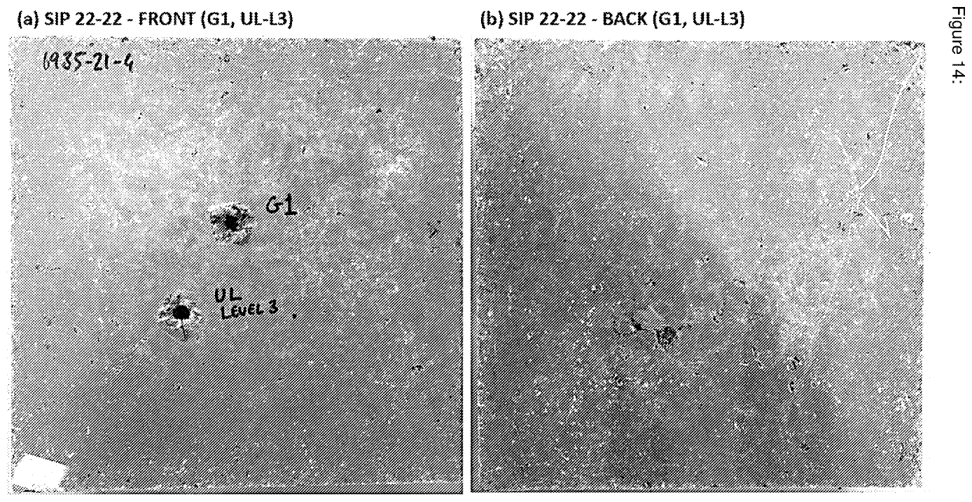

A 22-22 SIP panel system withstood the ballistic threat class G1 from a calibre. 357 magnum SJFN (158 grains nominal) with an impact velocity of 450 m/s without perforation or any spalling or bulging at the distal surface, as seen in FIG. 14.

TABLE 7
US: Standard UL-752 (Underwriters Laboratory) Protection Level Ratings

| | | | | Velocity | Velocity | Velocity | No. of |
|---|---|---|---|---|---|---|---|
| Ratings | Ammunition | Weight | (g) | Min FPS | Max FPS | MPS | Shots |
| Level 1 | 9 mm Full Metal Copper Jacket with Lead Core | 124 | 8.00 | 1175 | 1293 | 358 | 3 |
| | | grains | | | | | |
| Level 2 | .357 Magnum Jacketed Lead Soft Point | 158 | 10.20 | 1250 | 1375 | 385 | 3 |
| | | grains | | | | | |
| Level 3 | .44 Magnum Lead Semi-Wadcutter Gas Checked | 240 | 15.60 | 1350 | 1485 | 411 | 3 |
| | | grains | | | | | |
| Level 4 | .30 Caliber Rifle Lead Core Soft Point (.30-06 Caliber) | 180 | 11.70 | 2540 | 2794 | 774 | 1 |
| | | grains | | | | | |
| Level 5 | 7.62 mm Rifle Lead Core Full Metal Copper Jacket, Military Ball | 150 | 9.70 | 2750 | 3025 | 838 | 1 |
| | (.308 Caliber) NATO | grains | | | | | |
| Level 6 | 9 mm Full Metal Copper Jacket with Lead Core | 124 | 8.00 | 1400 | 1540 | 427 | 5 |
| | | grains | | | | | |
| Level 7 | 5.56 mm Rifle Full Metal Copper Jacket with Lead Core (.223 | 55 | 3.56 | 3080 | 3388 | 939 | 5 |
| | Caliber) | grains | | | | | |
| Level 8 | 7.62 Rifle Lead Core Full Metal Copper Jacket, Military Ball | 150 | 9.70 | 2750 | 3025 | 838 | 5 |
| | (.308 Caliber) NATO | grains | | | | | |
| Supplementary | 12-Gauge Rifled Lead Slug | 1 | 28.30 | 1585 | 1744 | 483 | 3 |
| Shotgun | | oz. | | | | | |
| Supplementary | 12-Guage 00 Lead Buckshot (12 pellets) | 1.5 | 42.00 | 1200 | 1320 | 366 | 3 |
| Shotgun | | oz. | | | | | |

The same panel withstood impact from a calibre 44 Magnum LSWC (240 grains nominal) with an impact velocity of 412 m/s without perforation but with slight bulging at the distal surface. However, no damage of the witness card was observed, thereby passing the required test at UL-Level 3, as seen in FIG. 14.

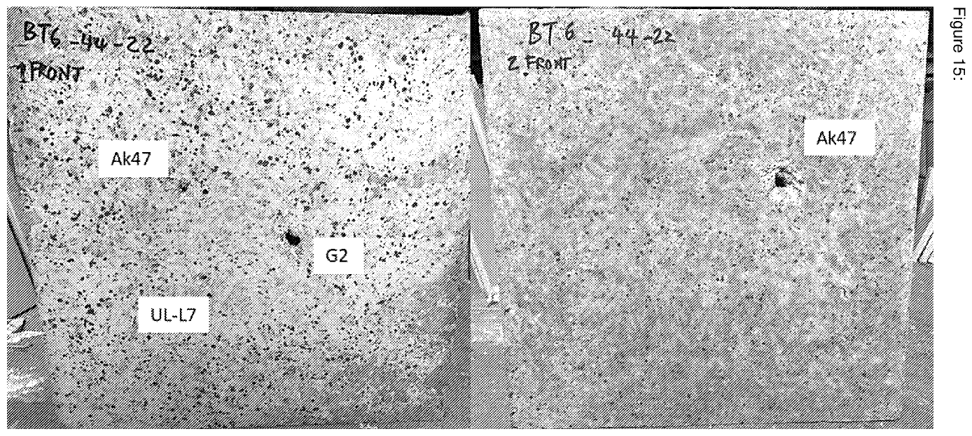

A 44-22 SIP panel according to the invention system withstood a calibre 5.56 FMJ, M193 (55 grains nominal) and 0.44 Magnum SJSP (240 grains nominal) with impact velocity of 969 m/s and 477 m/s respectively. No perforation was observed, and the surfaces remain largely intact. No damage of witness card was observed so that UL-Level 7 and Class G2 tests were passed, as shown in FIG. 15.

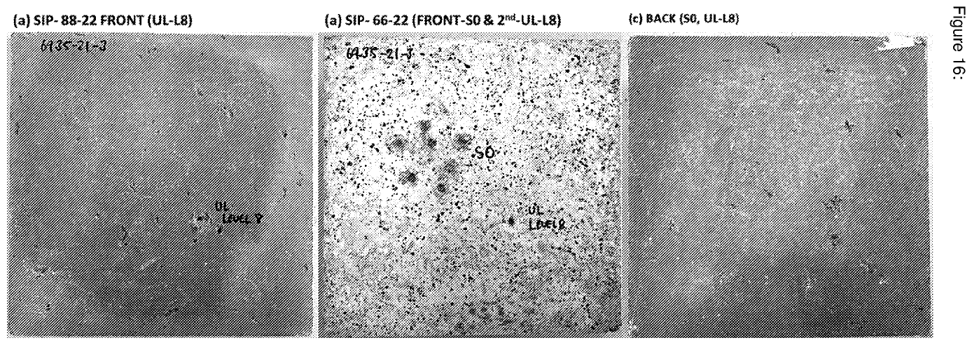

A 22-22 SIP panel according to the invention withstood a 12-gauge calibre SG shot (32 grains) with an impact velocity of 407 m/s without perforation and the pellets did not rebound, but remained inside the specimens. As a result, Class S0 has been passed by this panel, as seen in FIG. 16.

A 66-22 SIP panel according to the invention withstood a protection class level—NATO—308 Winchester calibre FMJ, M80 (150 grains) shot with an impact velocity of 849 m/s without perforation and the bullets penetrated through up to 66 mm. No witness card damage was observed and the pellets stuck inside the specimens by absorbing all impact energy. As a result, a 110 mm solid, or 88-22 SIP panel, subjected to the ballistic threat Class R1 or equivalent to UL Level 8 has been passed with minimal impact damage, as seen in FIG. 16.

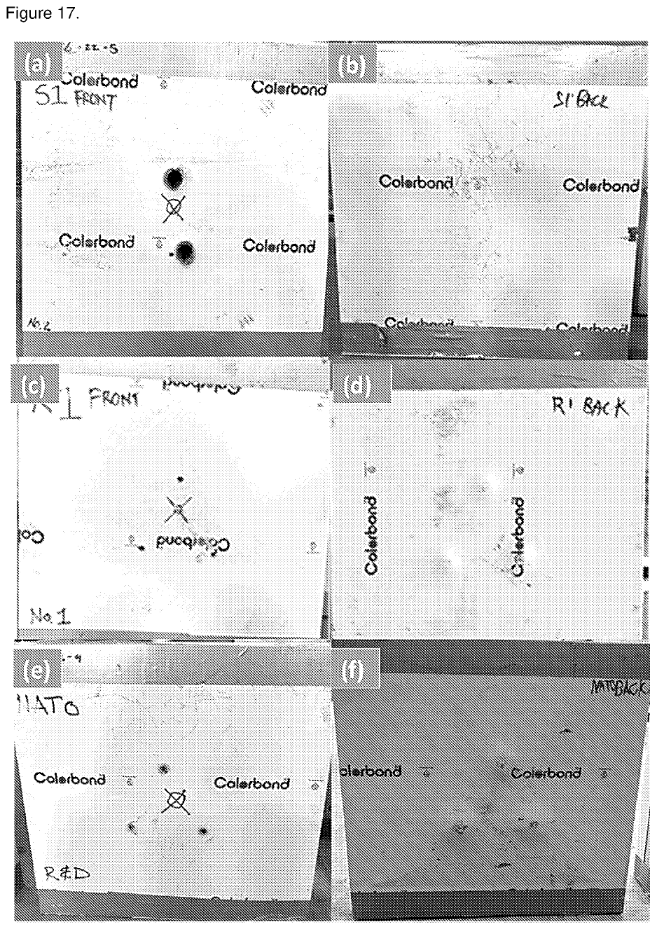

FIG. 17 shows various SIP panels with permanent metal formwork (0.55 bmt colour-bond in this test) subjected to the thread Class S1, R1 and NATO (AS/NZS 2343).

Further invention of the inventive 44-22 SIP ballistic panel with permanent formwork has shown that it passes the ballistic test for protection level Class NATO in accordance with AS/NZS 2343. The 35-35 SIP panels with permanent formwork have also passed the same test.

Moreover, the joint area of the SIP panels have also achieved a significant degree of ballistic resistance. A 22-22 SIP panel (with permanent formwork) joint withstands protection level Class-UL L3, while 25-25 SIP panel joints with permanent formwork withstand Class S1.

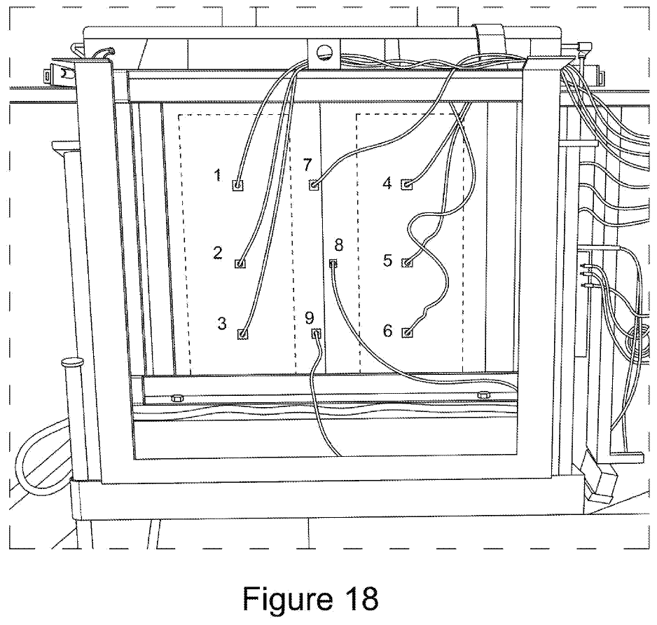

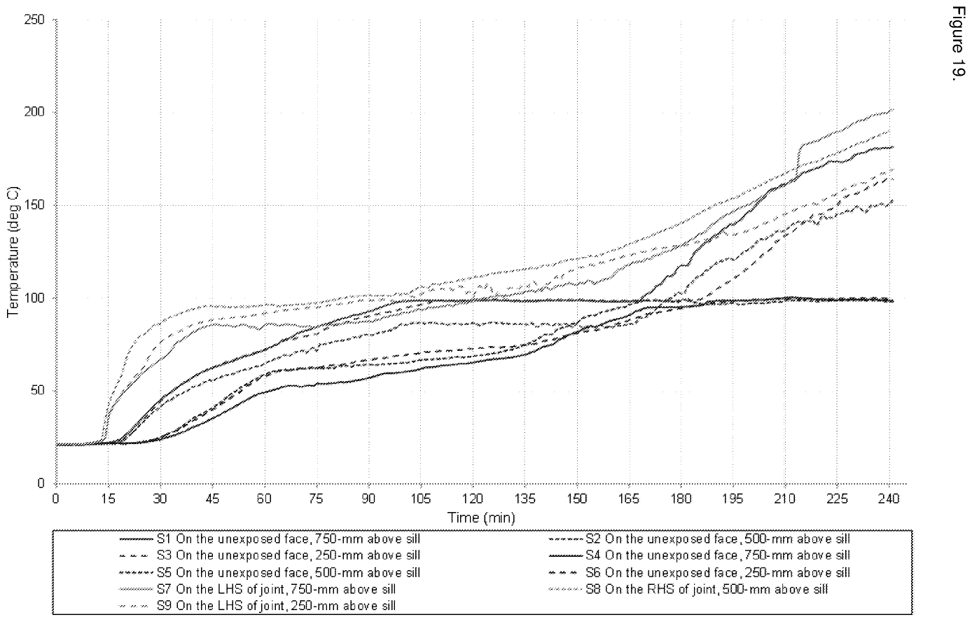

The inventors have also performed pilot fire tests for 25-25 SIP panels with 19 mm Magnesium board joint blocker and it has achieved a 4 hour fire rating as shown in FIGS. 18 and 19.

It will be appreciated by those skilled in the art that the above-described embodiment is merely one example of how the inventive concept can be implemented. It will be understood that other embodiments may be conceived that, while differing in their detail, nevertheless fall within the same inventive concept and represent the same invention.

1-45. (canceled)

46. An anti-ballistic building panel made substantially from: one of, or a combination of: magnesium oxychloride hydrate cement, magnesium oxysulphate hydrate cement and magnesium phosphate cement; wherein said cement also incorporates one or more of: high elastic modulus fibres and/or stone chips, preferably granite chips; and low elastic modulus fibres; said fibres and/or chips being distributed through said cement; said panel having an increased ability to resist damage when subjected to ballistic impact, said anti-ballistic properties being the ability to ameliorate any one of the following failure modes: shattering, spalling, bulging or fragmentation according to AS/NZS 2343 or equivalent standard.

47. The anti-ballistic building panel of claim 46, wherein said high-modulus fibre materials are one or more materials selected from the group comprising: carbon fibre, steel fibre, copper fibre, Kevlar, titanium, graphite, alkali-coated C-glass fibreglass, and glass fibre staples.

48. The anti-ballistic building panel of claim 46, wherein said low-modulus material are selected from the group comprising: poly-vinyl acetate (PVA) fibre, poly-propylene (PP) fibre and poly-ethylene (PE) fibre.

49. The anti-ballistic building panel of claim 46, wherein said stone chips are granite chips, of between 1 mm and 20 mm, preferably less than 10 mm, in largest dimension; said stone chips preferably having a Moh's scale of hardness in the range 6-7; and preferably a specific gravity of between 2000 and 3000 kg/m³.

50. The anti-ballistic building panel of claim 46, wherein the inclusion of high-modulus fibre is in the range of 0.5% to 1.0%, while that of low-modulus fibre is between 1.0% to 2.0% of the respective mass fraction of said cement.

51. The anti-ballistic building panel of claim 50, further incorporating expanded perlite.

52. The anti-ballistic building panel of claim 50, further incorporating organic waste fibre.

53. The anti-ballistic building panel of claim 50, further incorporating aluminium oxide grains of between 1 mm and 5 mm in size.

54. The anti-ballistic building panel of claim 50, further incorporating one or more of: exfoliated vermiculite, rice husk, banana trunk fibre, expanded perlite and dolomite.

55. The anti-ballistic building panel of claim 50, further incorporating one or more of: light burnt magnesia; magnesium salts; and cementitious industrial by-products.

56. The anti-ballistic building panel of claim 55, wherein said magnesium salts include one or more of: magnesium chloride hexahydrate, magnesium sulphate heptahydrate and magnesium phosphate.

57. The anti-ballistic building panel of claim 55, wherein the molecular ratio of light burnt magnesia to magnesium salts is in the range 7 to 11.

58. The anti-ballistic building panel of claim 55, wherein said light burnt magnesia has greater than 80% of MgO purity, an activity of 58% to 70%, and a particle size is less than 45 μm.

59. The anti-ballistic building panel of claim 55, wherein said cementitious material is one or more materials selected from the group consisting of: fly ash, silica fume, ground granulated blast-furnace slag.

60. The anti-ballistic building panel of claim 46, wherein water to dry mix composition ratio of the cement is between 0.30 to 0.60 by weight.

61. The anti-ballistic building panel of claim 46, further incorporating one or more of: phosphate additives; moisture and corrosion resistant agents, such as phosphoric acid; sodium mono-fluorophosphate; sodium hexametaphosphate; high performance water reducer agents; active cationic organo- and silane-based water-resistant agents.

62. An anti-ballistic building panel system, incorporating two or more building panels according to claim 46, separated by a gap maintained by a supporting frame.

63. The anti-ballistic building panel of claim 46, wherein said magnesium cement is selected from one of more of: magnesium oxychloride hydrate cement; magnesium oxysulphate hydrate cement; a hybrid of both said materials; and magnesium phosphate cement; said panels having an increased ability to resist damage when subjected to ballistic impact, said anti-ballistic properties being the ability to ameliorate any one of the following failure modes: shattering, spalling, bulging or fragmentation according to AS/NZS 2343 or equivalent standard; wherein said cement also incorporates one or more high-modulus fibre materials distributed through the cement and one or more low-modulus fibre materials distributed through the cement; and wherein said cement also incorporates one or more of: high elastic modulus fibres and/or stone chips, preferably granite chips; and low elastic modulus fibres; said fibres and/or chips being distributed through said cement.

64. A method of manufacture of magnesium cement as defined in claim 46, wherein said magnesium cement is selected from one of more of: magnesium oxychloride hydrate cement; magnesium oxysulphate hydrate cement; a hybrid of both said materials; and/or magnesium phosphate cement; said method including the incorporation in said cement of one or more high-modulus fibre materials distributed through the cement and one or more low-modulus fibre materials distributed through the cement.

65. The method of claim 64, further including the step of incorporating stone chips, preferably granite chips, of between 1 mm and 20 mm, preferably less than 10 mm, in largest dimension; said granite preferably chips having a Moh's scale of hardness in the range 6-7; and preferably a specific gravity of between 2000 and 3000 kg/m3, in said cement.

66. The method of claim 64, further including the step of incorporating in said cement one or more materials selected from the group comprising: expanded perlite; organic waste fibre; aluminium oxide grains of between 1 mm and 5 mm in size; and exfoliated vermiculite.

67. The use of granite chips in the manufacture of an anti-ballistic building panel made substantially from magnesium oxychloride hydrate cement; magnesium oxysulphate hydrate cement; a hybrid of both said materials; and/or magnesium phosphate cement, to fully or partially replace high modulus steel fibres to improve resistance to corrosion without substantially reducing anti-ballistic performance; wherein said panels have an increased ability to resist damage when subjected to ballistic impact, said anti-ballistic properties being the ability to ameliorate any one of the following failure modes: shattering, spalling, bulging or fragmentation according to AS/NZS 2343 or equivalent standard.

68. The use of one or more of high elastic modulus fibres and/or stone chips, preferably granite chips; and low elastic modulus fibres in the manufacture of an anti-ballistic building panel made substantially from magnesium oxychloride hydrate cement; magnesium oxysulphate hydrate cement; a hybrid of both said materials; and/or magnesium phosphate cement, to eliminate or reduce the occurrence of multicracks and/or spider-net-like failure mode under projectile impact; wherein said panels have an increased ability to resist damage when subjected to ballistic impact according to AS/NZS 2343 or equivalent standard.

69. The use of magnesium oxychloride hydrate cement, magnesium oxysulphate hydrate cement, magnesium phosphate cement; or a hybrid of one or more of said materials; as a substrate in the manufacture of an anti-ballistic building panel; wherein said panels have an increased ability to ameliorate any one of the following ballistic failure modes: shattering, spalling, bulging or fragmentation, according to AS/NZS 2343 or equivalent standard.
